(19) United States
(12) Patent Application Publication
(10) Pub. No.: US 2017/0068228 A1
(43) Pub. Date: Mar. 9, 2017

(54) METHOD AND ASSEMBLY FOR OPERATING A SANITARY FIXTURE

(71) Applicant: Grohe AG, Hemer (DE)

(72) Inventors: Heiko SCHOENBECK, Hemer (DE); Achim MIELKE, Porta Westfalica (DE)

(73) Assignee: Grohe AG, Hemer (DE)

(21) Appl. No.: 15/256,935

(22) Filed: Sep. 6, 2016

(30) Foreign Application Priority Data
Sep. 4, 2015 (DE) 10 2015 011 386.0

(51) Int. Cl. G05B 15/02; E03C 1/18; A47K 3/28; E03D 9/00; E03D 13/00

(52) U.S. Cl. CPC G05B 15/02; E03D 9/00; E03D 13/005; A47K 3/281; E03C 1/18

(57) ABSTRACT

A method of operating a sanitary fixture including at least the steps of: a) defining a plurality of zones of a surrounding area of the sanitary fixture; b) detecting a current ambient situation by a sensor device; c) setting a default ambient situation; d) monitoring the plurality of zones by the sensor device; e) initiating an action of the sanitary fixture when with step d), a characterizable change in the ambient situation is detected. An assembly is also provided having at least one sensor device and a sanitary fixture. The sanitary fixture has a control unit for setting at least one actuator of the sanitary fixture. The sensor device has a measuring unit for detecting ambient situations of the sanitary fixture, and the measuring unit is data-conductively connected with the control unit.

This nonprovisional application claims priority under 35 U.S.C. §119(a) to German Patent Application No. 10 2015 011 386.0, which was filed in Germany on Sep. 4, 2015, and which is herein incorporated by reference.

### BACKGROUND OF THE INVENTION

Field of the Invention

The present invention relates to a method for operating a sanitary fixture and an assembly comprising at least one sensor device and a sanitary fixture. In particular, a method and assembly are described, with which an automatic or demand-driven operation of the sanitary fixture is made possible, in particular in respect of the initiation of actions preceding and/or following the use of the sanitary fixture.

Description of the Background Art

Increasingly, users of sanitary fixtures wish for completely independent, additional functions or actions in sanitary fixtures to be carried out prior to or after their actual use. Thus, it may for example be desirable that with a water closet, the lid be raised, the seat cover preheated and/or disinfected, or a cleaning performed. With showers, it may be desired that the jet nozzle, the beam shape, the lighting of the shower cabin, the underfloor heating, etc. be operated demand-driven, thus conserving energy and water. With a vanity, for example, it may be desired that it can automatically detect, which water connection will be selected from a plurality of water connections for a hands-free operation. There are similar requirements also with regard to a urinal, as already described above in connection with the water closet.

In order to carry out such functions or actions by the sanitary fixture without concrete involvement of the user, such as the operation of buttons, sensor elements have been proposed that can trigger some of that function independently. In particular, distance sensors, touch sensors and/or motion sensors have been presented. However, a disadvantage with respect to these sensors is that they often provide only binary signals, so either the “on” or the “off” state. In other words, to comprehensively control the above-identified sanitary fixtures, complicated, sometimes unnatural or uncomfortable operating concepts need to be implemented, and/or it is necessary to utilize a plurality of sensors.

### SUMMARY OF THE INVENTION

It is therefore an object of the present invention to at least partially solve the problems described related to the prior art. In particular, a method for operating a sanitary fixture is to be provided, which, with less technical effort, possibly avoiding specific adverse environmental effects, makes a needs-based and/or automatic operation of these “service functions” possible in sanitary fixtures. In particular, the assembly should be set up so that in particular in case of the simplest possible technical construction, a robust signal evaluation is guaranteed. In addition, it is desirable in this case to proceed so that the method, whenever necessary, automatically adjusts to changes in the surrounding area of the sanitary fixture.

In an exemplary embodiment a method for operating a sanitary fixture is provided, which includes at least the following steps: (a) defining a plurality of zones in the surrounding area of the sanitary fixture; (b) detecting a current ambient situation by means of a sensor device; (c) setting a default ambient situation; (d) monitoring the plurality of zones by means of the sensor device; (e) initiating an action of the sanitary fixture, if in step d) a characterizable change in the ambient situation is detected.

The object of the method is, in particular, to independently or automatically perform actions before, during and/or after the actual use of the sanitary fixture.

During the (initial commissioning or repeated) set-up of the method or, where appropriate, at predetermined times, preferably a so-called environment analysis is performed according to step a). For this purpose, the surrounding area in or around the sanitary fixture is divided into several zones, which can then be monitored independently. The zones are in particular those flat or spatial areas of the surrounding area that can be detected by sensors, in particular by separate or separately responsible sensor units of a sensor device. It is preferred that a plurality of zones is set in an immediate area surrounding the sanitary fixture, and in a distant area surrounding the sanitary fixture. In this way, for example, at least 2, 3 or 4 zones, preferably at least 12 zones, or even more zones, can be established. Particularly preferred is that half of the zones relate to the immediate surrounding area and the other half to the distant surrounding area. Setting the zones can be done taking into account the surroundings of the sanitary fixture and/or can be predetermined by the structure of the sensor device. The zones are each freely configurable and can overlap if necessary.

In step b), the current ambient situation is now detected by a sensor device. This includes in particular, that by means of the sensor device, each of the plurality of zones is individually detected by sensors. This serves in particular to determine and/or to note malfunctions as to how the area around the sanitary fixture, or the multiple zones, detected by the sensor are not fully accessible due to structural conditions (wall projections, furniture, windows, sloping ceilings, curtains, etc.). To this extent, it is also possible that step b) is carried out several times in order to obtain assurance regarding the current ambient situation (without the user).

Step c) has as a result that the so-called default ambient situation is determined. In particular, this default ambient situation is stored for later comparisons and/or as a basis for the subsequent evaluation by the sensor device. Thus, it is now clear, which zones may be freely crossed by a user to which extent, or which default values are to be detected by the sensor device, if no use of the sanitary fixture is pending.

Once this preparatory and/or verification process comprising the steps a), b) and c) has been performed, the actual monitoring period can begin. The sensor device is now used to monitor the multiple zones. The monitoring especially pursues the goal that changes within the multiple zones lead to changes in measurement results, which can then be analyzed and evaluated. During step d), the sensor device is therefore active.

If in step d) a characterizable change in the ambient situation is detected, then a default action of the sanitary fixture can be triggered (step e)). “Characterizable” is a change in the ambient situation in particular if the sensor device or measurement units in contact therewith or control units are able to assign the identified metrics to a certain behavior of the user, so that a possibly concretely selected action thereto is performed. This will be explained briefly with two examples: For example, in step c), it can be determined, where with respect to this sanitary fixture or to the sanitary room, an entrance door and the sanitary fixture itself are located. If it now follows from the monitoring in step d) that an object is moving from the entrance door towards the sanitary fixture, it can be concluded that the sanitary fixture will soon be used, so that, for example, a toilet seat is raised and/or a pre-cleaning is carried out. If, for example, a user reaches for toilet paper, this can also be characterized and can initiate another action of the sanitary fixture, such as a cleaning process and/or odor extraction.

According to a preferred embodiment of the method, it is proposed that in step b) and in step d), a plurality of zones be scanned, each with associated sensor units of the sensor device. This means in particular that the sensor units operate contact-free and a sensor unit is explicitly assigned to only one part of the multiple zones actually provided. In particular, it is provided that a sensor unit monitors or scans one zone, two zones or a maximum of three zones. In this respect, a zone-specific analysis of the ambient situation of the sanitary fixture can be made.

It is also proposed that a number of zones are scanned at different times with the sensor device. In other words, for example, this means that several zones are provided in a plane around the sanitary fixture that are arranged particularly mutually adjacent. The activation of each relevant sensor unit can be carried out at different times so that the planes are monitored or scanned in zones, in particular from one zone to the adjacent zone. This may be, for example, a standard scan process in case currently no moving object is detected in the plurality of zones. The order or the frequency of acquisition of measurement data within a zone or adjacent zones can then be adjusted if a corresponding change in specific zones is given. This method is particularly appropriate when the sensor units access a common receiver or a common measurement unit.

It is further proposed that the characterizable change is a movement or gesture of a user of the sanitary fixture. A “movement” of the user is here understood to mean the motion sequence common for the use of the sanitary fixture. This relates to, for example, walking toward or into the sanitary fixture, grasping for accessory products (soap dispenser, dryer, light switch, etc.) and/or the user remaining at a predetermined position in the vicinity of the sanitary fixture. A “gesture” of the user, for example, is understood to be a predefined posture of the user, for example, of the arms or the hands of the user, which is concretely specified. In this way, for example, on the basis of gestures, individual commands can be recognized or a selection can be made from a user menu. The gestures can thereby be defined within a zone or across zones.

In addition, it is considered advantageous that in step e), at least the following sub-processes take place: comparison of the detected change in the ambient situation using predetermined modification schemes; selection of an appropriate modification scheme; and/or selection of at least one action for operating the sanitary fixture as a function of the selected, suitable modification scheme.

Thus, for this method option, there is a direct interpretation of the detected modification in the ambient situation based on modification schemes that are predetermined or learned as part of the operation of the sanitary fixture. The predetermined modification schemes can also be learned on site. For this purpose, movements and/or gestures can be specified by the user in a “learning mode” of the sensor device, which are then available for selection in the subsequent actual operation of the sanitary fixture. In other words, this means in particular that the change in the ambient situation detected by the sensor unit is tracked or interpreted and is metrologically compared to various stored or previously known modification schemes. If there is sufficient agreement, a concrete (already stored or retrievable) modification scheme is selected, and the action for actuating the sanitary fixture that is also stored or provided is performed. To clarify, it should be noted that the actuation of the sanitary fixture need not be a single action, but may also possibly include several actions, in particular staggered in time. In addition, the monitoring scheme of the sensor device can then be adjusted depending on the selected and appropriate modification schemes, especially if it is expected that the user will then behave in a predetermined manner.

It is also proposed that step d) comprises activating an actuator for moving a component of the sanitary fixture. The actuator may be mechanical and/or electronic. Components that may be considered are components used for supply, i.e., dispensing fluids via the sanitary fixture (such as valves, thermostats, heaters, jet formers, etc.), as well as external components that enable or support the use. Such external components may be a vent, heater, a lid, a flap or the like.

It is further proposed that steps b) and c) are repeated intermittently and step d) is carried out more frequently or continuously. In other words, this means that according to the steps b) and c), the (metrological) set-up of the system is repeated at predetermined time intervals. This way, for example, it can be established whether new furniture has been placed in the room or existing furniture has been moved. There are preferably several hours or several days between a repetition of steps b) and c), so that these steps can also be matched with a calendar, if needed. In contrast, the monitoring of the multiple zones is preferably performed continuously or much more frequently, for example, several times a minute, or even several times per second. It is also possible that an initiation of step d) is previously required, such as when the light is turned on in the room or if a door is opened, from which can be seen that only now, a use of the sanitary fixture could be imminent.

According to another aspect, an assembly is proposed which comprises at least one sensor device and one sanitary fixture. The sanitary fixture has a control unit for setting (or regulating) at least one actuator of the sanitary fixture. The sensor device has a measuring unit for the detection of ambient situations of sanitary fixtures. In addition, the measuring unit is (electronically or electrically) connected to the control unit in such a way that data are conducted. The assembly is suitable and arranged to perform the method presented here. With this assembly, in particular, there is a (spatial) separation of the evaluation of the signals of the sensor device. While measurement or electronic conversion of measured values takes place within the sensor device by means of the measuring unit, these measurement data are then passed to a control unit, which is preferably part of the sanitary fixture itself. In the control device, in particular step e) is carried out, wherein there, also the aforementioned sub-processes i. ii., and iii. are preferably carried out. Hence, an analysis or interpretation of the measured values takes place in the control unit of the sanitary fixture. The control unit can be an element of the individual sanitary fixture or a superordinate control unit for the use or operation of several sanitary fixtures.

The above-described facts in connection with the method can equally be used to characterize the assembly. This also applies vice versa for the subsequently presented notes on the assembly, which are clearly also applicable with the method.

In the assembly, it is also preferred if said sensor device has a plurality of light emitters which can reach several zones of the environment of the sanitary fixture separately, and at least one light receiver. Consequently, it is especially preferred that a light emitter is responsible for one or more zones, and can reach these (alone or separately). In addition, a (single) light receiver is then provided, which can then receive and process the reflecting light rays from the surroundings of the sanitary fixture.

In this sense, it is especially preferred that the sensor device includes infrared LED as a light emitter.

Based on the measurement of the duration of light pulses, in particular light from light emitting diodes (LED) in the visible or infrared spectrum, the sensor device is particularly adapted to determine the position of users or objects in the vicinity of the sanitary fixture and preferably also their distance from the sanitary fixture or from the sensor device. Here, the LEDs preferably generate a widening or diffuse beam of light that covers a broader range (a zone) of the surrounding area. The light receiver detects the light components backscattered from the objects or the user in the beam of the LED, and independently analyzes their waveform. Thus, in the individual zones of the light beam, an existing object or a user moving in said zones can be recognized. Based on the time it takes the light beam to return from the respective object or user to the light receiver (duration), the distance or the type of movement is determined.

The LEDs are in particular used to generate very short light signals, typically 100,000 pulses per second. The so-called “time-of-flight” principle essentially includes measuring the time needed for a light pulse to travel from the light emitter to an object or a user of the sanitary fixture and from there, back to the light receiver (round trip time). The distance R of the detected object/user is calculated based on the measured round trip time T of the light pulse on the basis of the simple formula: R=c T/2 n (c is the speed of light in vacuum and n is the refractive index of the medium (air) in which the light pulse propagates). Depending on the surface properties of the object/user, there is absorption, total reflection, or diffuse (scattered) reflection of the emitted light. As a result, the echo pulse arrives at the light receiver with varying intensity, which is measured there. The measured intensity is thus a function of the measured distance and the angle of incidence, which can be determined with the aid of an image-capturing optical system, which focuses the reflected light beam. In particular, for the application in the present case according to which the sensor device includes infrared LED, the zone or the beam width can be chosen in particular with the following angular ranges starting from a central point in the vicinity of the sanitary fixture: 3°, 9°, 18°, 24°, 34°.

This solution especially applies to a sanitary fixture which can include, for example, water closet, shower, wash basin, toilet, or urinal.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates an embodiment of an assembly for carrying out the method described;

FIG. 2 illustrates an assembly for performing the method; and

FIG. 3 illustrates an assembly for carrying out the method.

### DETAILED DESCRIPTION

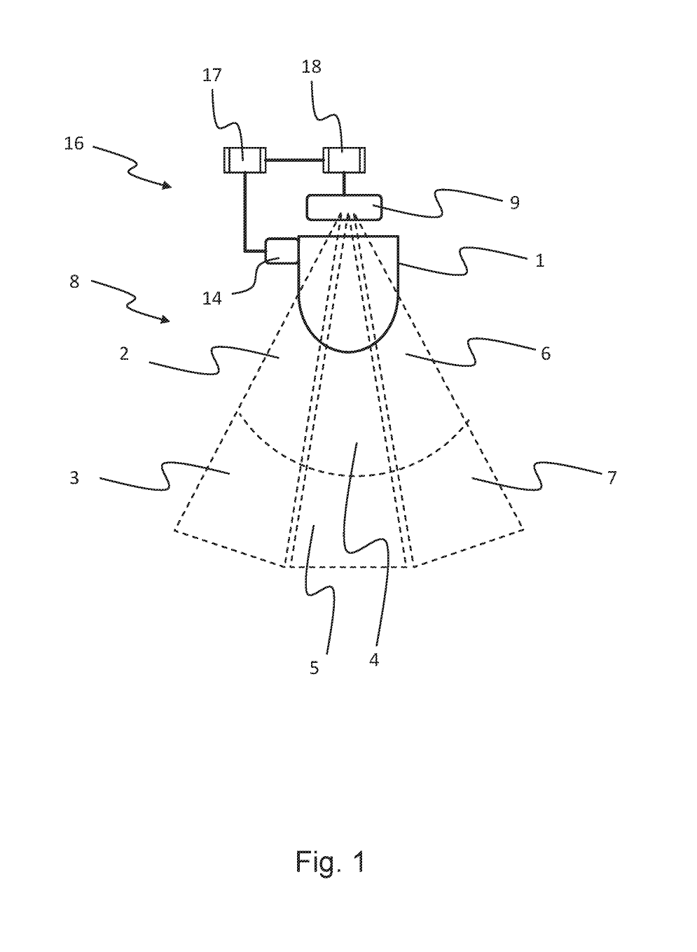

FIG. 1 shows an assembly 16 for carrying out an operating method of a sanitary fixture 1 described herein. The sanitary fixture 1 is shown here in the manner of a water closet, however, the illustrated principle can equally be applied to a shower, a wash basin and/or a urinal, without the need for further additions for the sanitary expert addressed here. Above the sanitary fixture 1, a (central) sensor device 9 is provided, which comprises a measuring unit 18. The measuring unit 18 may for example include a microprocessor or an electronic data processing unit. The measuring unit 18 is data-conductively connected to a control unit 17, which is connected to an actuator 14 of the sanitary fixture 1. The latter connection may in turn be electrical in nature, but a mechanical coupling would also be possible. The control unit 17 may for example include a microprocessor or an electronic data processing unit. The component 15 can be, for example, a heating element for the water closet and/or a lid opening device.

Moreover, this illustrates how multiple zones can be detected by sensors or by measurement using the sensor device 9. Thus, the sensor device 9 of the assembly 16 is designed such that said assembly forms three essentially opening zones which are each divided into an immediate area and a distant area. Shown on the left of FIG. 1 are a first immediate zone 2 and a first distant zone 3. Adjacent thereto and in the central area, a second immediate zone 4 and a second distant zone 5 are formed. On the right side, the monitoring area closes again with a third immediate zone 6 and a third distant zone 7. The sensor device 9 is now set up and configured to detect or capture objects/users or movements within these zones 2, 3, 4, 5, 6, 7.

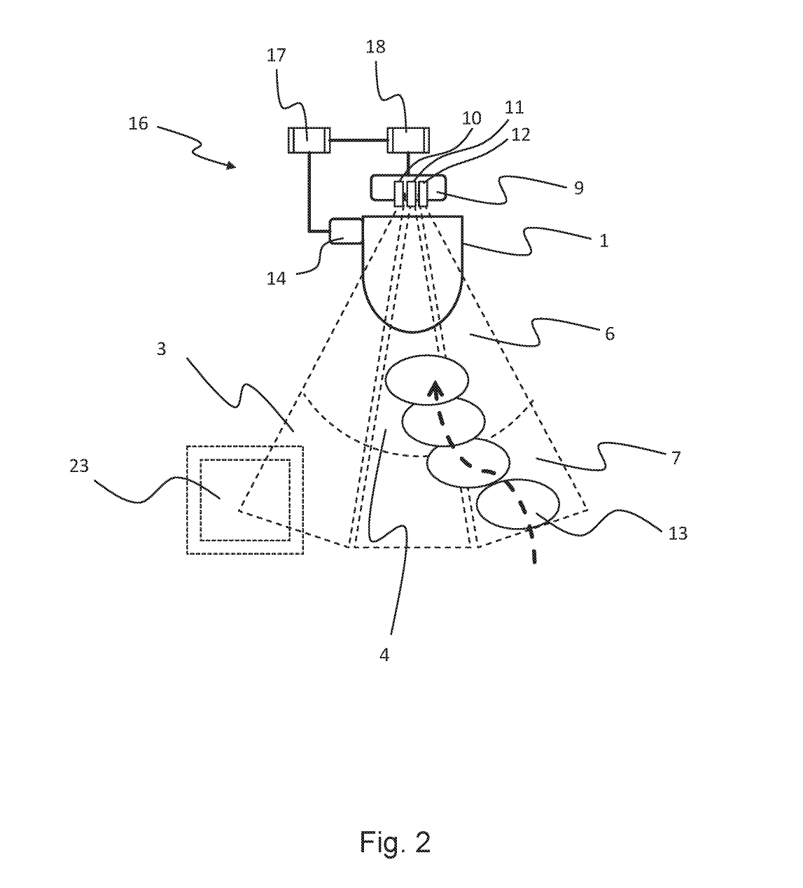

FIG. 2 illustrates a particular situation during use. On the left side of FIG. 2, it can be seen that the assembly 16 is equipped with a sensor device 9, which has a separate sensor unit for each zone region. Thus, for the first immediate/distant zone, a first sensor unit 10 is provided, for the second immediate/distant zone, a second sensor unit 11, and for the third immediate/distant zone, a third sensor unit 12. These autonomously and independently monitor their zones. On the left, it can be seen that an object 23 is placed in the region of the first distant zone 3. This can be, for example, a cabinet in the bathroom, which is motionless and has been placed there motionless, at least for a longer period of time. As part of the steps a), b) and c), this is detected as a static object and is thus excluded from the subsequent evaluation or monitoring according to steps d) and e). In other words, this object 23 is switched to be “blind”.

The right or central area now illustrates how a user 13 approaches the sanitary fixture 1. By monitoring the zones 6, 7, 4, and in particular with their temporal evaluation, the measuring unit 18 detects a characteristic change in the ambient situation (step d)). On this basis, it compares the detected change of the ambient situation with a predetermined change scheme, for example, stored in the control unit 17, in which case there is a selection of the appropriate modification scheme and an action, for example, lifting the lid, is carried out via the actuator 14 as a function of the identified modification scheme.

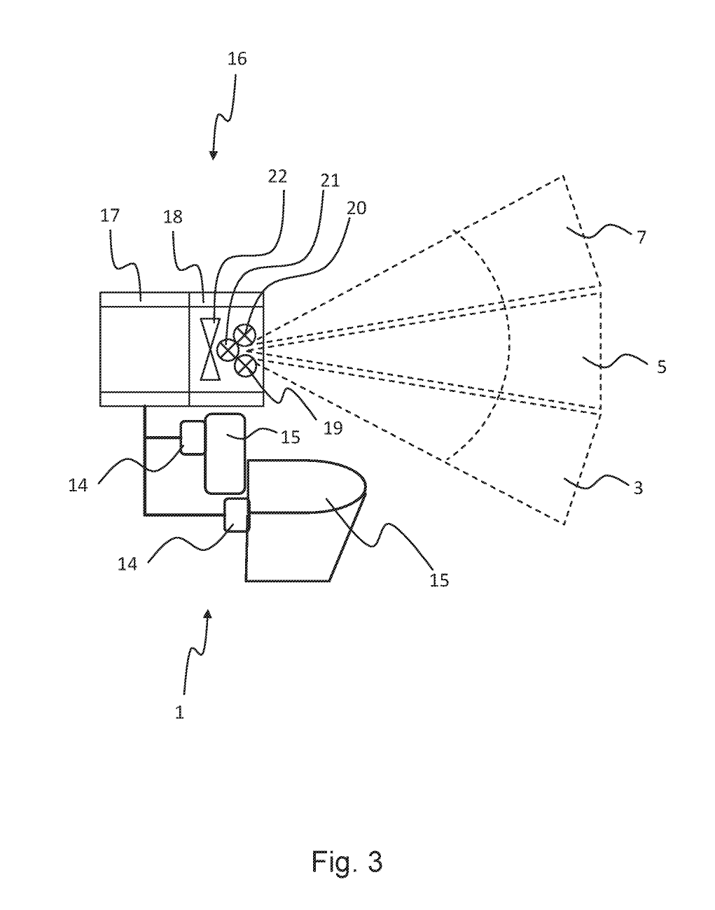

FIG. 3 illustrates in particular the situation that the zones may be formed not only horizontally but also vertically, where appropriate. In addition, FIG. 3 illustrates that the sensor device comprises a plurality of light emitters (first light emitter 19, second light emitter 20, third light emitter 21) and a common light receiver 22. Here, also, the modification is shown of the measuring unit 18 and the control unit 17 directly interacting with each other, for example on a common data processing unit. The control of actuators 14 by the control unit 17 may then occur demand-driven on the different components 15 of the sanitary fixture 1. For example, a valve for flushing, a current supply to the electric seats, the initiation of air extraction, the triggering of fragrances, the sending of entertainment information, etc., take place automatically.

Thus, here a method is specified for operating a sanitary fixture, which enables a needs-based and/or automatic operation of these “service functions” in sanitary fixtures with less technical effort, possibly even avoiding specific adverse environmental effects. The assembly is set up so that a simple technical construction and a robust signal evaluation are ensured. In addition, it is possible for the method to automatically adapt to changes in the surrounding area of the sanitary fixture.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method of operating a sanitary fixture comprising:
a. defining a plurality of zones of a surrounding area of the sanitary fixture;
b. detecting an actual ambient situation via a sensor device;
c. setting a default ambient situation;
d. monitoring the plurality of zones via the sensor device; and
e. initiating an action of the sanitary fixture, when in step d), a characterizable change in the ambient situation is detected.

2. The method according to claim 1, wherein in step b) and in step d), a plurality of zones, each having associated sensor units of the sensor device, are scanned.

3. The method according to claim 1, wherein a plurality of zones are scanned offset in time with the sensor device.

4. The method according to claim 1, wherein the characterizable change is a motion or gesture of a user of the sanitary fixture.

5. The method according to claim 1, wherein step e) further comprises:
comparing the detected change in the ambient situation using predetermined modification schemes;
selecting an appropriate modification scheme; and/or
selecting at least one action for operating the sanitary fixture as a function of the selected, suitable modification scheme.

6. The method according to claim 1, wherein step e) further comprises an activation of an actuator for moving a component of the sanitary fixture.

7. The method according to claim 1, wherein steps b) and c) are repeated intermittently and step d) is carried out more frequently or continuously.

8. An assembly comprising:
at least one sensor device; and
a sanitary fixture, the sanitary fixture comprising a control unit for setting at least one actuator of the sanitary fixture,
wherein the sensor device has a measuring unit for detecting ambient situations of the sanitary fixture,
wherein the measuring unit is data-conductively connected with the control unit, and
wherein the assembly is configured for performing a method according to claim 1.

9. The assembly according to claim 8, wherein the sensor device comprises a plurality of light emitters that separately reach a plurality of zones of the surrounding area of the sanitary fixture and further comprises at least one light receiver.

10. The assembly according to claim 9, wherein at least one of the plurality of light emitters is an infrared LED.

11. The assembly according to claim 8, wherein the sanitary fixture is a water closet, a shower, a wash basin, or a urinal.
